(19) United States
(12) Patent Application Publication
(10) Pub. No.: US 2026/0208488 A1
(43) Pub. Date: Jul. 23, 2026

(54) DIGITAL PRINTING MODULE

(71) Applicant: BOBST MEX SA, Mex (CH)

(72) Inventors: Roberto VALTERIO, Ollon (CH); Walter URECH, Seengen (CH)

(73) Assignee: BOBST MEX SA, Mex (CH)

(21) Appl. No.: 19/140,765

(22) PCT Filed: Dec. 20, 2023
(86) PCT No.: PCT/EP2023/086793

§ 371 Date: Jun. 18, 2025

(30) Foreign Application Priority Data
Dec. 22, 2022 (EP) 22215875.0

(51) Int. Cl. B41J 2/165; B31B 50/00; B31B 50/04; B31B 50/88; B31B 100/00; B41J 3/28; B41J 3/54; B41J 11/00; B41J 25/316

(52) U.S. Cl. CPC B41J 2/16552; B31B 50/88; B41J 2/16579; B41J 3/286; B41J 3/543; B41J 11/0095; B41J 25/316; B31B 50/006; B31B 50/042; B31B 2100/00; B41J 2002/16558; B41J 2002/16594

(57) ABSTRACT

The present invention relates to a digital printing module (22) comprising at least one print head (25) having a nozzle plate (27) provided with a plurality of nozzles (29). The print head is mounted in a rotatable chassis (106) allowing a rotation of the print head between a printing position (A) in which the nozzle plate is facing vertically upwards and a cleaning position (B) in which the nozzle plate is facing vertically downwards.

### FIELD OF THE INVENTION

The present invention relates to a digital printing module, which is particularly suitable for printing on paper, cardboard and plastics. Such a digital printing module can be integrated into a converting machine configured to produce folding boxes and similar packaging containers.

### BACKGROUND

Digital inkjet printing is often used when printing motifs on blanks for packaging elements, such as cardboard or paperboard boxes.

In the digital inkjet printing process, an inkjet print head is arranged such that the printing nozzles are facing downwards and whereby the ink droplets are ejected in the gravitational direction. This is advantageous in order to ensure that the droplets are conveyed in controlled manner in a straight direction until they are deposited onto the blank.

However, for some specific applications such as in converting machines, there is a need to provide different mechanical operations to a blank. Converting machines such as folder-gluers are used in the production of paperboard and cardboard boxes. These machines are configured to receive cut-to-shaped blanks and then fold and glue them to form folding boxes or other similar packaging containers.

The cut-to-shaped blanks are typically printed on the side which will make the outside face of the container. In the folder-gluer machine, due to the folding operations, the printed side needs to be placed in the feeder with its printed side facing downwards.

Document EP2512792B1 discloses a folder-gluer machine with a digital printing device arranged to print in a conventionally manner in the gravitational direction. The device in EP2512792B1 has a specific transportation path allowing the blanks to be printed from above, and then turned to position the printed surface downwards.

### SUMMARY

In view of the prior art, it is an object of the present invention to provide a digital printing device for a converting machine which is capable of printing on a bottom side of a blank without turning the blank.

This object is solved by a digital printing module according to claim 1 and a converting machine according to claim 10.

According to a first aspect of the present invention, there is provided a digital printing module comprising at least one print head, the print head comprising a nozzle plate provided with a plurality of nozzles. The print head is mounted in a rotatable chassis allowing a rotation of the print head between a printing position in which the nozzle plate is facing vertically upwards and a cleaning position in which the nozzle plate is facing vertically downwards.

The present invention is based on a realization that the cleaning of a print head can be facilitated if the print head can be positioned in a specific cleaning position. In this cleaning position, the accessibility of the print head is further improved.

In an embodiment, a plurality of print heads is arranged side by side in a cluster and wherein the cluster is located in the chassis.

It is also possible to group a plurality of clusters together. In a related embodiment, the digital printing module may comprise at least one printing assembly, the printing assembly comprising a plurality of clusters located in a common chassis.

In an embodiment, the digital printing module comprises a first printing assembly and a second printing assembly, each printing assembly comprising a plurality of clusters located in a separate common chassis, and wherein the first printing assembly is in the cleaning position while the second cluster is in the printing position.

In an embodiment, the digital printing module comprises further comprises a cleaning device provided with a movable cleaning member configured to move across and sweep off the nozzle plate of the at least one print head.

The cleaning module may be located laterally of the digital printing module.

In an embodiment, the cleaning member comprises a rinsing channel provided with a first and a second elongate seals, and wherein the cleaning module further comprises a cleaning liquid reservoir, and a liquid circulation pump configured to supply and evacuate liquid from the cleaning channel.

In an embodiment, the chassis is connected to a first and second guide rails and a displacement device, and wherein the displacement device is configured to displace the cleaning device under the digital printing module when a need for cleaning is detected.

In an embodiment, a first pressure sensor is located upstream of the print head and a second pressure sensor is located downstream of the print head, and wherein the need for cleaning is identified when the resistance over at least one print head exceeds a resistance threshold.

According to a second aspect of the present invention, there is provided a converting machine configured to receive blanks and fold and glue the blanks to form folding boxes, wherein the converting machine comprises a digital printing module according to any of the previously mentioned embodiments, a feeder module, a folding module and a gluing module. The folding module is preferably configured to fold lateral flaps of the blank upwardly. In such a way, the printed motif from the digital printing module is positioned on the outside surface of the packaging element.

The digital printing module is preferably located upstream of the folding module in a direction of transportation of the blanks.

In an embodiment, the converting machine further comprises an optical inspection module, wherein the optical inspection system is configured to detect the location of ink droplets on the blank and determine a need for cleaning of the at least one print head.

The optical inspection system may be configured to determine an effective printing field on the blank, said effective printing field represents and area in which printing can be performed without printing errors.

In an embodiment, a control unit of the inspection module is configured to propose a displacement of the printed area on the blank.

### BRIEF DESCRIPTION OF THE DRAWINGS

The invention will now be described with reference to the appended drawings, in which like features are denoted with the same reference numbers and in which:

FIG. 1 is a schematic view of a converting machine in the configuration of a folder gluer;

FIG. 2 is schematic top view of a blank;

FIG. 3 is a schematic perspective view of a printing cluster;

FIG. 4 is a schematic diagram of the fluidic system of a digital printing device according to an embodiment of the present invention;

FIG. 5 is a schematic diagram of a digital printing module according to an embodiment of the present invention;

FIG. 6 is a schematic diagram of a digital printing module according to another embodiment of the present invention;

FIG. 7 is a schematic perspective view of a vacuum conveyor;

FIG. 8 is a schematic perspective view of a plurality of printing clusters mounted in a common chassis according to an embodiment of the present invention;

FIG. 9 is a schematic diagram of cleaning module;

FIGS. 10a to 10c are schematic diagrams of a printing cluster in an operating position and in the start and finish of a cleaning position; and

FIG. 11 is a schematic diagram of a digital printing module comprising two printing assemblies.

### DETAILED DESCRIPTION

The present invention can be used solely for printing purposes and in the form of a printing module. The present invention can also be used in many types of converting machines like folder-gluers, flexo folder gluers and rotary die-cutter machines. However, in order to simplify the present description, reference is made to a folder-gluer machine.

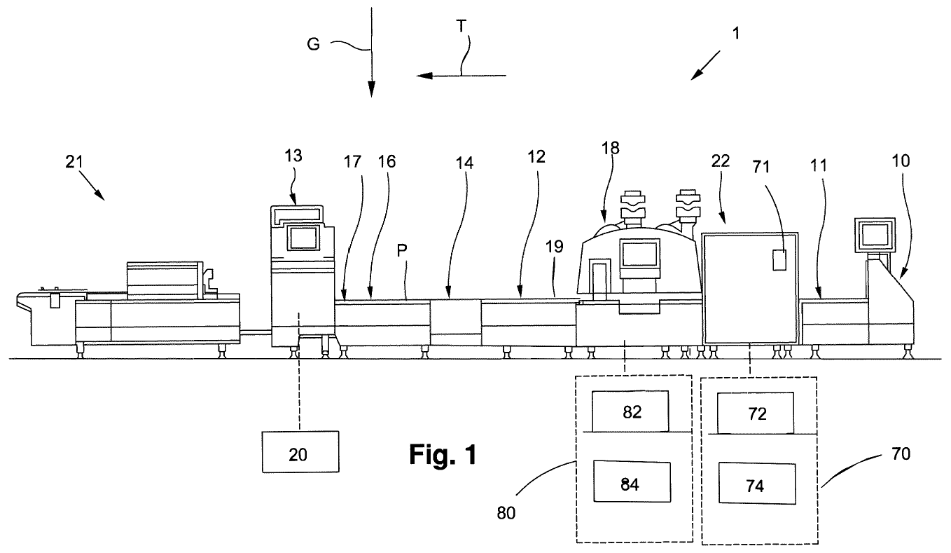

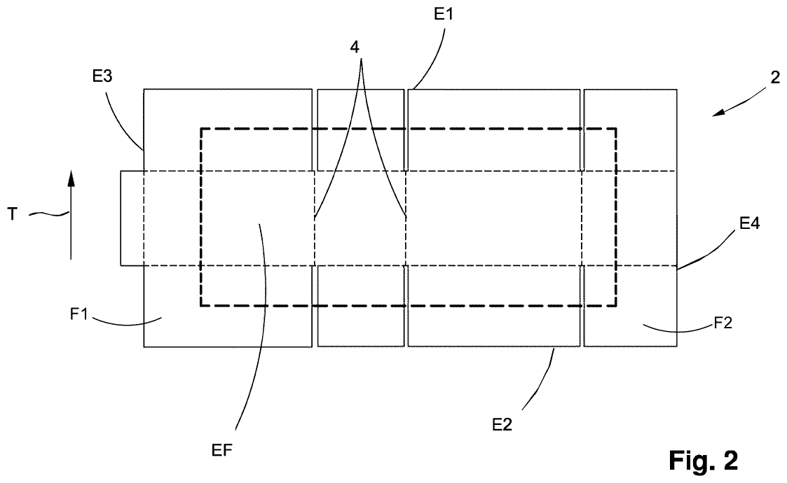

Referring to the figures and in particular to FIGS. 1 and 2, which illustrate a folder-gluer machine 1 and a blank 2 to be processed therein. The folder-gluer machine 1 is configured to receive a cut-to-shaped blank 2, and then fold and glue the blank 2 to form packaging elements. The packaging elements may be folding boxes or other folded and glued packaging containers. The blanks 2 are conveyed along a transportation path P through the converting machine 1.

The folder-gluer machine 1 may comprise a series of different workstations in the form of modules. The modules may include, from an inlet to an outlet and in a direction of transportation T: a feeder module 10, an alignment module 11, a fold pre-breaking module 12, a gluing module 14 and a folding module 16. The folder-gluer machine 1 may further comprise a main user interface 13 and an inspection module 18. The folding module 16 is preferably configured to fold lateral flaps F1, F2 of the blank 2 upwardly. In such a way, the printed motif from the digital printing module 22 is positioned on the outside surface of the packaging element.

The alignment module 11 is arranged downstream in the direction of transportation T of the feeder module 10 and is configured to laterally align the blank 2 to a predefined lateral position. The predetermined lateral position is defined by the position of the longitudinal crease lines 4 and the position of folding and auxiliary tools in the converting machine 1. The alignment module 11 is thus configured to align the blank 2 in a direction D which is perpendicular to the direction of transportation T. Optionally, an ejection module 17 is located after the folding module 16. The ejection module may be configured as described in document EP2976279 A1.

After the gluing and folding modules, a delivery module and conditioning section 21 can be provided in order to count and separate a shingled stream of folding boxes into separate batches.

The converting machine 1 further comprises a conveyance system 19 comprising conveyors such as endless belts and rollers configured to transport the blanks 2 in the direction of transportation T. The converting machine 1 also comprises a central control circuitry 20 configured to control the operation of the converting machine 1.

The present converting machine 1 further comprises a digital printing module 22 in the form of an inkjet printing module 22. Preferably, the digital printing module 22 is located downstream of the alignment module 11. The digital printing module 22 is located upstream of the folding module 16 in the direction of transportation T of the blanks 2.

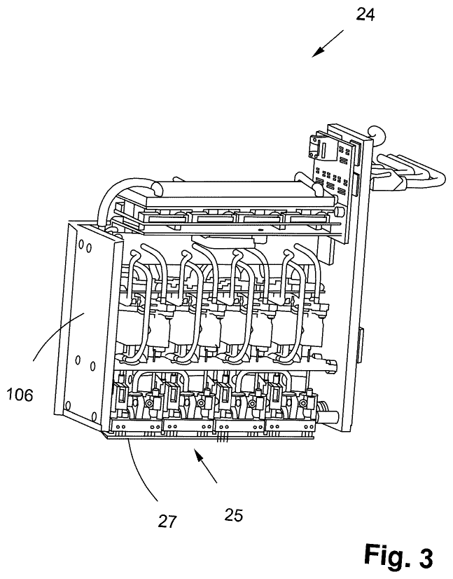

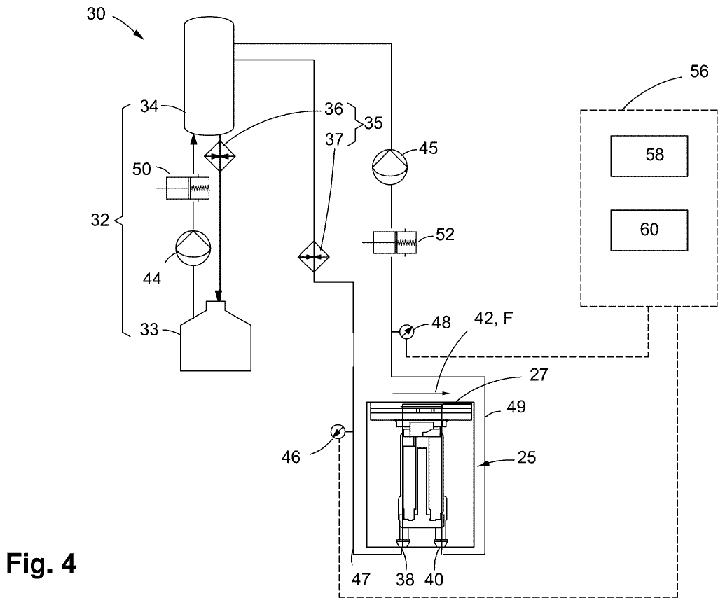

As best seen in FIGS. 3 and 4, the inkjet printing module 22 comprises an inkjet printing system 30 including at least one print head 25. Each print head 25 comprises a nozzle plate 27. Preferably, the inkjet printing system 30 comprises a plurality of print heads 25 arranged in printing clusters 24. Each cluster 24 comprises a plurality of print heads 25 grouped and attached together.

The printing cluster 24 is arranged with the nozzle plates 27 positioned underneath the transportation path P of the blank 2. Each printing cluster 24 may be fluidically connected to a separate ink store 32. In order to print with several different colors, the inkjet printing system 30 may comprise a plurality of printing clusters 24 and ink stores 32.

As schematically illustrated in FIG. 4, the inkjet printing system 30 comprises an ink store 32 which may include a main reservoir 33 and a second reservoir 34. The main reservoir 33 is configured to store a large volume of ink, such as for instance 5 to 20 liters or even up to 1000 liters. The second reservoir 34 is configured to store a smaller volume of ink than the main reservoir 33. The second reservoir 34 may be connected in a closed loop to each separate print head 25 in the cluster 24. A heating system 35 is thermally connected to the ink from the second reservoir 34. The heating system 35 may comprise a first and a second heating elements 36, 37 configured to heat the ink in a fluidic circuit upstream of the print head 25 and/or in the print head 25.

The print head 25 comprises a fluid inlet 38, through which ink can enter the print head 25, a fluid outlet 40, through which ink can exit the print head 25, and an ink channel 42 connecting the fluid inlet 38 and the fluid outlet 40.

An inlet pump 44 and a first pressure sensor 46 are arranged on a fluidic inlet circuit 47 to the print head 25. The inlet pump 44 is located upstream of the print head. Preferably, the inlet pump is located between the main reservoir 33 and a second reservoir 34.

The first pressure sensor 46 is located between the second reservoir 34 and the print head 25. Preferably, the first pressure sensor 46 is located at the fluid inlet 38 to the print head 25.

An outlet pump 45 is located on an outlet circuit 49 from the print head 25. A second pressure sensor 48 is arranged on the fluidic outlet circuit 49 from the print head 25. The inlet pump 44 and the outlet pump 45 cooperate such that the ink is mechanically supplied to and mechanically evacuated from the print head 25. In such a way, the flow F of ink is mechanically controlled over the print head 25. This mechanical control of the fluid flow F over the print head 25 reduces the impact on the ink flow F from the gravitational force.

To reduce pulsations in the ink flow in the proximity of the print head 25, a first damper 50 may be located downstream of the inlet pump 44.

Additionally, a second damper 52 is located upstream of the outlet pump 45. The first and second dampers 50, 52 may comprise a receptacle comprising a capsule of air. The capsule of air forms an air cushion which absorbs pulsations as the fluid enters into the dampers 50,52.

In such a way, pulsations in the ink flow F can be reduced in the print head 25. The first damper 50 reduces the upstream pulsations in the ink flow F and the second damper 52 reduces the downstream pulsations in the ink flow F. Consequently, a more continuous ink flow F is obtained in the ink channel 42 in the print head 25.

The inkjet printing system 30 further comprises a control circuitry 56. The control circuitry 56 comprises a control unit 58 and a memory 60. The inlet pump 44, the outlet pump 45 and the first and second pressure sensors 48, 50 are connected to the control circuitry 56.

The first and second pressure sensors 48, 50 are configured to continuously provide a respective inlet P1 pressure and outlet pressure P2 to the control unit 58. Based on the detected inlet and outlet pressures P1, P2, the control unit 58 determines the meniscus pressure Pm.

In particular, a too high a meniscus pressure Pm can lead to air intake, while a too low meniscus pressure Pm can result in nozzle plate flooding. Moreover, a pulsation in the meniscus pressure Pm can lead to periodic effects in the print output.

The control unit 58 is further configured to modify the rpm of the outlet pumps 44, 45 and to correct the meniscus pressure Pm.

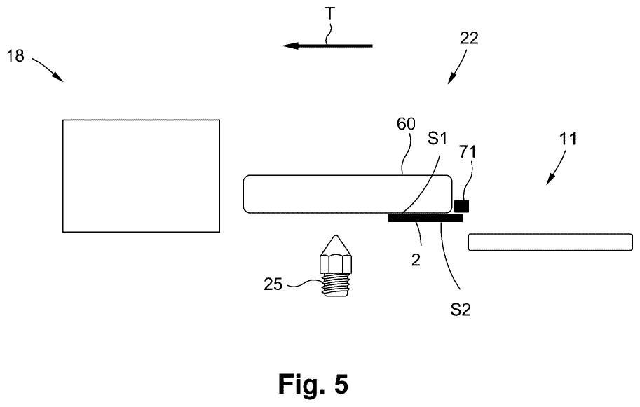

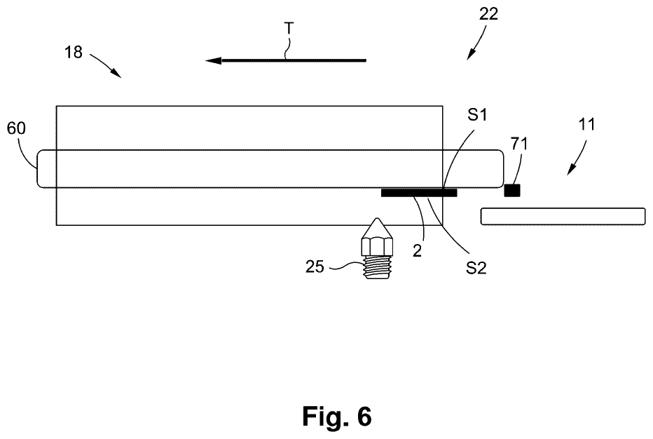

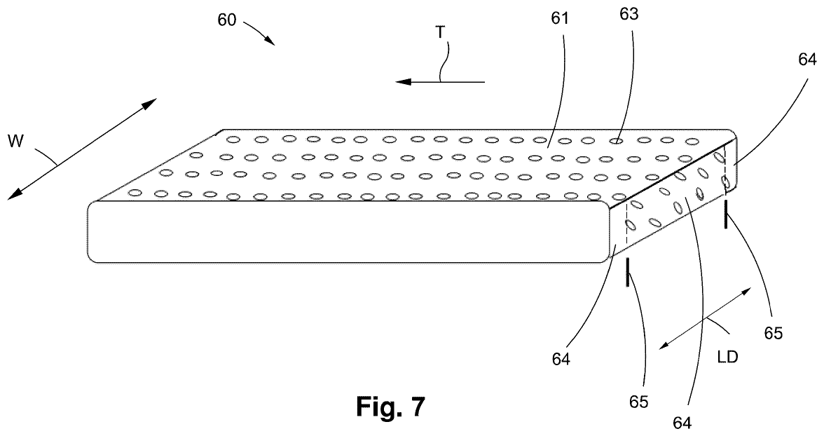

As best seen in FIGS. 1, 5 and 6, at the outlet of the alignment module 11, a vacuum transfer conveyor 60 is positioned with a suction surface facing a top side S1 of the blank 2. The vacuum transfer conveyor 60 ensures that the blank 2 is immediately positioned and grasped at the outlet of the alignment module 11. As schematically illustrated in FIG. 7, the vacuum transfer conveyor 60 may comprise a conveyor belt 61 provided with suction openings 63 and having a width W exceeding the width of the blank 2.

The vacuum transfer conveyor 60 may comprise a plurality of suction boxes 64. The vacuum suction boxes may comprise internal shutters 65 which limit the lateral suction LD distance of the vacuum transfer conveyor 60. The internal shutters 65 may be automatically displaced in order to laterally restrict the suction force and such that the shutters are aligned with the width of the blank 2. In such a way, the perturbation and influence caused by the suction of uncovered suction openings 63 in the conveyor belt 61 can be reduced.

Preferably, the blank 2 is only conveyed by the vacuum transfer conveyor 60 as the printed motif is being deposited on the blank 2. Hence, the blank 2 is no longer retained in the alignment module 11 as the motif is being deposited on the blank 2. This avoids potential displacements of the blank 2 caused by any mechanical touching element such as a guide in the alignment module 11.

The print heads 25 are located below the vacuum transfer conveyor 60 and are configured to print on the bottom side S2 of the blank 2 upon a signal from a transfer sensor 71. The print heads 25 are arranged to eject liquid in a direction which is opposite to the gravitational direction G.

The blanks 2 are subject to longitudinal register shifts in the direction of transportation T, and there is a variation in their arrival time to the print head 25. If the position of the blanks 2 is not controlled and corrected, there is a risk that the printed motif is not placed on the predefined correct position on the blanks 2.

To ensure that the printing is effectuated at the correct longitudinal position on the blank 2, the printing module 22 preferably comprises a register control system 70.

As best seen in FIGS. 1, 5 and 6, the register control system 70 comprises a transfer sensor 71, a control unit 72 and a memory 74. The transfer sensor 71 is located upstream of the print head 25. The sensor 71 can be an optical sensor with background suppression. The transfer sensor 71 is configured to detect the position of the front edge E1 or the rear edge E2 of the blank 2 as the blank 2 is conveyed by the vacuum transfer conveyor 60.

The transfer sensor 71 provides a detection signal to the control unit 72 upon the passage of the blank. Subsequently, the control unit 72 calculates the estimated arrival time of the blank 2 to the print head 25. The estimated arrival time may be calculated by adding an additional transportation time to the detection time. The additional transportation time may be calculated from the transportation speed of the vacuum transfer conveyor 60.

The memory 74 comprises a program to allow the control unit 72 to calculate the arrival time and the desired jetting activation time for each print head 25.

When printing close to an external edge E1, E2, E3, E4 of the blank 2, some suction openings in the vacuum transfer conveyor 60 are not covered by the blank 2, and these suction openings 63 are close to the ink nozzles

This results in that some ink droplets may either be sucked into the vacuum transfer conveyor 60, or have their trajectory changed due to an aerodynamic effect from the vacuum transfer conveyor 60. Consequently, the accuracy in the printed motif is reduced when the trajectory of the ink droplets is changed. It is therefore advantageous to limit the digital printing field to a central portion of the blank 2 and to define an effective printing field EF (as illustrated in FIG. 2).

The effective printing field EF is limited by the distortion effect caused by the vacuum transfer conveyor 60. The distortion effect is caused by:
The size of the blank 2; Hence, the smaller the blank 2, the higher the calibrated suction force of the vacuum transfer conveyor 60 needs to be. There will be less obstructed openings 63 in the vacuum transfer conveyor 60 to hold the blank 2 and each suction opening 63 needs to apply a stronger suction force.
The geometry of the blank 2 and the shape of the edge close to the printed motif. The shorter the lateral edge E3, E4 is in the direction of transportation T, the more unobstructed suction openings 63 and the higher the distortion effect becomes at the lateral edge E3, E4 of the blank 2.

The distortion of the droplets can be visually detected by the operator upon inspection of the blank 2 or the vacuum transfer conveyor 60.

An inspection module 18 is preferably located downstream of the digital printing module 22.

The inspection module 18 preferably comprises a camera and an illumination system as disclosed in document EP3221221. The inspection device 18 further comprises a control circuitry 80. The inspection module 18 may be configured to detect the location of printed motifs and text and compare them to pdf specifications, and perform inspections of foil and varnishes. The inspection module 18 may be further configured to perform color measurement to check if the printed colors match a pdf print specification and detect the location of embossing elements (such as cushioning or braille embossing). The distortion effect from the unobstructed suction openings 63 can also be detected with the inspection module 18.

The present control circuitry 80 of the inspection module 18 can be configured to detect and calculate register displacement distances. In such a way, the desired timing of the jet activation can be adjusted.

The present inspection module 18 may also determine the effective printing field EF. Hence, the inspection module 18 may define the effective printing field EF where the interference from a peripheral suction force is within a tolerable range. The memory 84 of the inspection module 18 may therefore comprise a program enabling the control unit 82 to calculate tolerance distances from the external blank edges E1, E2, E3, E4 based on the geometry of the blank 2.

The control unit 82 may propose a displacement of the digitally printed area. The proposed displacement may be visually displayed on a user interface/monitor 13. The control circuitry 80 may generate a proposed corrected file of the blank 2 artwork and send to a remote client site for approval. The control system may also be connected in a network to a remote client site. Optionally, the step of transmitting a proposed image file is only performed upon approval from a command entered into the interface 13 of the converting machine 1.

The inspection device 18 may be further configured to send corrective settings to the print head 25. Alternatively, the inspection module 18 can be configured to generate an error message to stop the converting machine 1.

The inspection module 18 may be configured to detect clogged or erroneous nozzles. The control unit 82 is configured to calculate a correction in order to activate of adjacent nozzles in the nozzle plate 27, while deactivating the erroneous nozzles.

The memory 84 may further comprise a program to allow the inspection module 18 to determine the need of cleaning the cluster 24 based on the detected deterioration in the printed motif.

Additionally, the inspection module 18 can be configured to detect individual blanks 2 with printing errors. The individual blanks 2 can be tagged and ejected from the converting machine 1 by the ejection device 17.

The printing cluster is configured to eject ink in a direction opposite to the gravitational direction G. This allows the printing of a bottom surface of the blank. However, there may be ink droplets which do not settle of the blank and instead fall down onto the printing cluster. When ink settles on the nozzle plate, some nozzles may become clogged. Clogged nozzles will result in an undesirable absence of print in some areas on the blank.

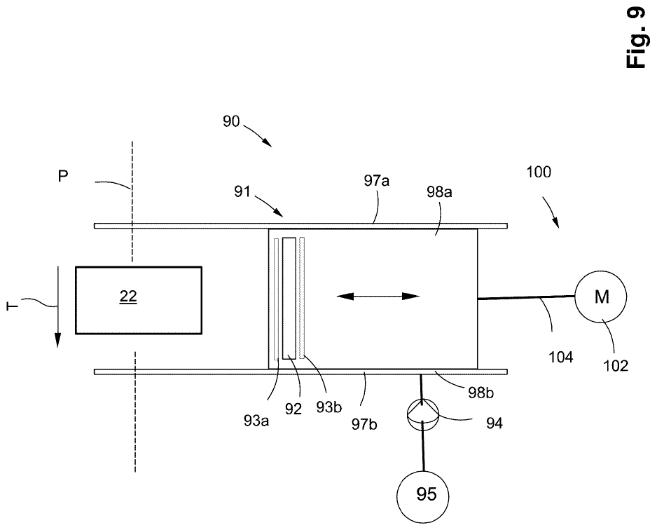

A cleaning module 90 is schematically illustrated in FIG. 9. The cleaning module 90 may comprise an elongated movable cleaning member 91. The cleaning member comprises a rinsing channel 92 located between a first elongate seal 93a and a second elongate seal 93b. A pump 94 is configured to supply a cleaning liquid from a liquid reservoir 95 to an inlet of the rinsing channel 92. The elongated cleaning member 91 is movable such as to sweep off the entire surface of the nozzle plate 27.

The cleaning module 90 can be fixedly located underneath the print head 25.

Alternatively, and preferably, the cleaning module 90 is arranged laterally of the processing path P of the converting machine 1. The cleaning module 90 is laterally movable from an inactive position outside of the transportation path P to a cleaning position located under the print head 25. The cleaning module 90 can be moved in a direction D, which is perpendicular to the direction of transportation T.

As the rinsing channel 92 is arranged such that the liquid is maintained by gravity, the nozzle plate 27 of the print head 25 needs to be arranged with the nozzle plate 27 facing vertically downwards during cleaning.

The elongated cleaning member 91 is arranged to be laterally movable over the nozzle plates 27 of the print head 25. A first and a second guide rails 97a, 97b may support a first distal end 98a and a second distal end 98b of the cleaning member 91. A displacement device 100 comprising a motor 102 and an actuator 104 is connected to the cleaning member 91 and configured to displace the cleaning member 91 along the guide rails 97a, 97b.

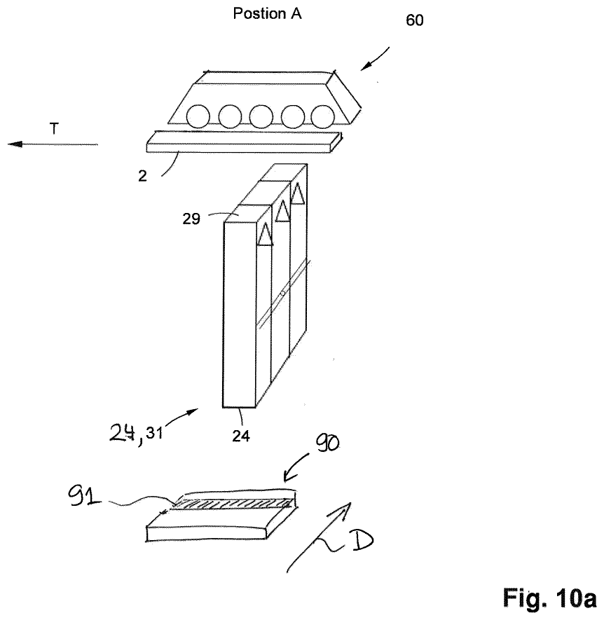

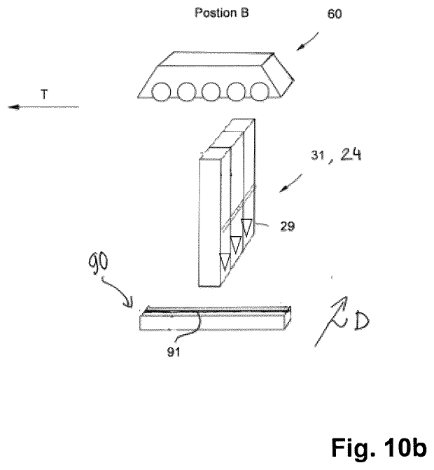

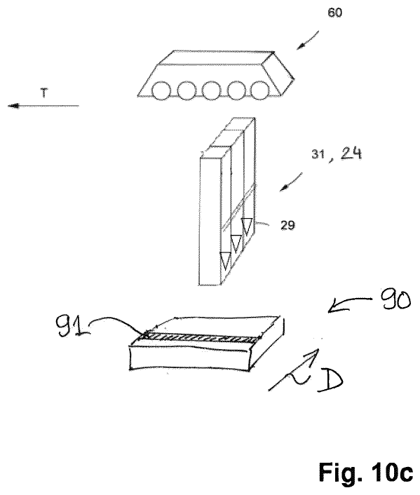

As illustrated in FIGS. 10a to 10c, a plurality of print heads 25 are assembled in a cluster 24. the printing cluster 24 is rotatably arranged between a printing position A and a cleaning position B. In the printing position A, the printing nozzles 29 are facing vertically upwards. Consequently, in the cleaning position B, the printing nozzles 29 are facing vertically downwards.

As illustrated in FIG. 3, each printing cluster 24 may be mounted in a separate chassis 106.

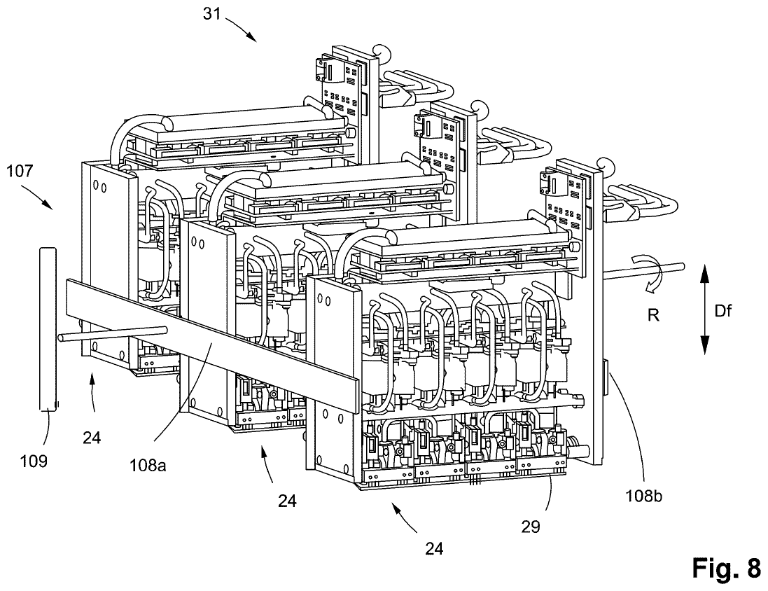

Alternatively, as illustrated in FIG. 8, a plurality of printing clusters 24 can be located as a printing assembly 31 in a common chassis 107. It is further possible to provide a plurality of printing assemblies 31, where a group of clusters 24 is contained in a separate common chassis 107.

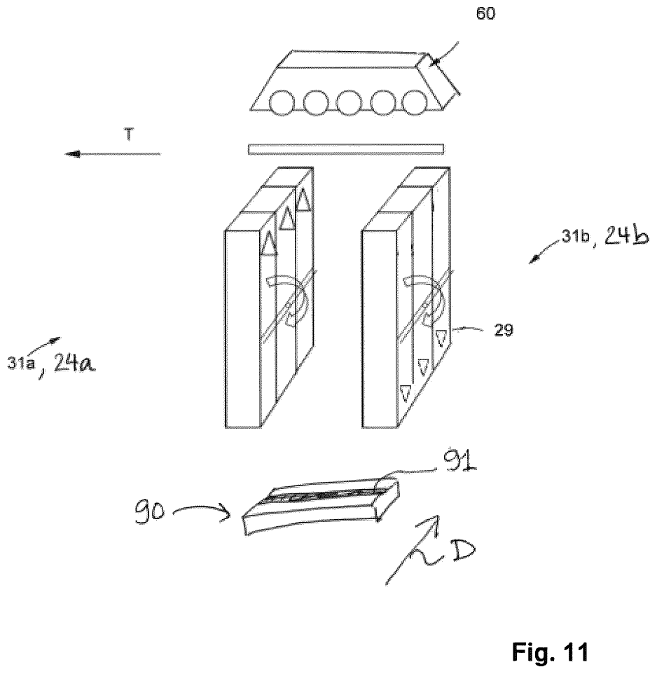

As illustrated in FIG. 11, this enables simultaneous printing with a first printing cluster 24a or a first printing assembly 31a, and a simultaneous cleaning of the second printing cluster 24b or printing module 31b. That is, one printing assembly 31a may be in the printing position A and jetting ink droplets on the blanks 2, while the other printing assembly 31b is in the cleaning position B. However, if no need for printing is determined, the first and second printing assemblies 31a, 31b may be operated simultaneously in the printing position A.

The common chassis 107 is rotatably connected to a structural frame 109 of the printing module 22. The common chassis 107 of the printing assembly 31 is connected to the structural frame 109 in a first bracket 108a and second bracket 108b. The brackets 108a, 108b are connected to a rotational axis R. The rotational axis R may be located in the gravitational center of the common chassis 107.

The rotation of the printing assembly 31 is preferably performed after the printing assembly 31 is vertically displaced at a distance Df. The frame 109 can thus be vertically movable between the printing position A and the cleaning position B.

To allow the ink circuits to accommodate for the rotational movement, the ink conduits may have a rotational connection to the cluster 24.

Typically, dry ink which deposited onto the nozzle plate 27 reduce the jetting capacity of the nozzles 29. This results in that some nozzles 29 may become closed or partially clogged such that they stop dispensing ink or that they deviate the ejected droplets. This results in that the ejected droplets are not deposited in the desired location on the blank 2.

As the dry ink starts to build up on the nozzle plate 27, the resistance Ri over the print head 25 increases. The control unit 58 may send a message to the user interface 13 and stop the converting machine 1 when the resistance Ri exceeds a threshold value Rt.

Additionally, or alternatively, and as previously described, the optical inspection module 18 can also detect a need for cleaning. The inspection module 18 is configured to detect the position of the printed elements on the blank 2 and to compare the captured image with a desired image stored in the memory 60 of the control circuitry 56.

1. A digital printing module comprising at least one print head, the print head comprising a nozzle plate provided with a plurality of nozzles, wherein the print head is mounted in a rotatable chassis allowing a rotation of the print head between a printing position in which the nozzle plate is facing vertically upwards and a cleaning position in which the nozzle plate is facing vertically downwards.

2. The digital printing module according to claim 1, wherein a plurality of print heads is arranged side by side in a cluster and wherein the cluster is located in the chassis.

3. The digital printing module according to claim 2, wherein the digital printing module comprises at least one printing assembly, the printing assembly comprising a plurality of clusters located in a common chassis.

4. The digital printing module according to claim 1, wherein the digital printing module comprises a first printing assembly and a second printing assembly, each printing assembly comprising a plurality of clusters located in a separate common chassis, and wherein the first printing assembly is in the cleaning position while the second cluster is in the printing position.

5. The digital printing module according to claim 1, further comprising a cleaning device provided with a movable cleaning member configured to move across and sweep off the nozzle plate of the at least one print head.

6. The digital printing module according to claim 5, wherein the cleaning module is located laterally of the digital printing module.

7. The digital printing module according to claim 5, wherein the cleaning member comprises a rinsing channel provided with a first and a second elongate seals, and wherein the cleaning module further comprises a cleaning liquid reservoir, and a liquid circulation pump configured to supply and evacuate liquid from the cleaning channel.

8. The digital printing module according to claim 5, wherein the chassis is connected to a first and second guide rails and a displacement device, and wherein the displacement device is configured to displace the cleaning device under the digital printing module when a need for cleaning is detected.

9. The digital printing module according to claim 1, wherein a first pressure sensor is located upstream of the print head and a second pressure sensor is located downstream of the print head, and wherein the need for cleaning is identified when the resistance over at least one print head exceeds a resistance threshold.

10. A converting machine comprising the digital printing module according to claim 1, wherein the converting machine is configured to receive blanks and fold and glue the blanks to form folding boxes, and wherein the converting machine comprises a feeder module, a folding module and a gluing module.

11. The converting machine according to claim 10, wherein the digital printing module is located upstream of the folding module in a direction of transportation of the blanks.

12. The converting machine according to claim 11, further comprising an optical inspection module, wherein the optical inspection module is configured to detect the location of ink droplets on the blank and determine a need for cleaning of the at least one print head.

13. The converting machine according to claim 12, wherein the optical inspection module is configured to determine an effective printing field on the blank, said effective printing field represents an area in which printing can be performed without printing errors.

14. The converting machine according to claim 13, wherein a control unit of the optical inspection module is configured to propose a displacement of the printed area on the blank.
